(19) United States
(12) Patent Application Publication
(10) Pub. No.: US 2021/0019599 A1
(43) Pub. Date: Jan. 21, 2021

(54) ADAPTIVE NEURAL ARCHITECTURE SEARCH

(71) Applicant: Google LLC, Mountain View, CA (US)

(72) Inventors: Hanna Mazzawi, New York, NY (US); Javier Gonzalvo Fructuoso, New York, NY (US); Eugen Surri Hotaj, New York, NY (US)

(21) Appl. No.: 16/933,690

(22) Filed: Jul. 20, 2020

Related U.S. Application Data
(60) Provisional application No. 62/876,548, filed on Jul. 19, 2019.

(51) Int. Cl. G06N 3/04; G06N 3/08

(52) U.S. Cl. CPC G06N 3/0454; G06N 3/08; G06N 3/0472

(57) ABSTRACT

Methods, systems, and apparatus, including computer programs encoded on computer storage media, for determining neural network architectures. One of the methods includes selecting a candidate architecture; selecting a neural network block from the set of neural network blocks; determining whether to (i) add the selected neural network block as a new neural network block in the candidate architecture or (ii) replace one of the neural network blocks in the selected candidate architecture with the selected neural network block; based on the determining, generating a mutated architecture; training a neural network having the mutated architecture on the training data; determining a performance measure for the trained neural network that measures the performance of the trained neural network on the particular machine learning task; and adding, to the maintained data, data specifying the mutated architecture and data associating the mutated architecture with the determined performance measure.

### CROSS-REFERENCE TO RELATED APPLICATION

This application claims priority to U.S. Provisional Application No. 62/876,548, filed on Jul. 19, 2019. The disclosure of the prior application is considered part of and is incorporated by reference in the disclosure of this application.

### BACKGROUND

This specification relates to determining architectures for neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Some neural networks are recurrent neural networks. A recurrent neural network is a neural network that receives an input sequence and generates an output sequence from the input sequence. In particular, a recurrent neural network can use some or all of the internal state of the network from a previous time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allow the cell to store previous states for the cell, e.g., for use in generating a current activation or to be provided to other components of the LSTM neural network.

### SUMMARY

This specification describes a system implemented as computer programs on one or more computers in one or more locations that determines a network architecture for a task neural network that is configured to perform a particular machine learning task.

Particular embodiments of the subject matter described in this specification can be implemented so as to realize one or more of the following advantages. By determining the architecture of a task neural network using the techniques described in this specification, the system can determine a network architecture that achieves or even exceeds state of the art performance on any of a variety of machine learning tasks, e.g., image classification or another image processing task or speech recognition, keyword spotting, or another audio processing task. Additionally, the system can determine this architecture in a manner that is much more computationally efficient than existing techniques, i.e., that consumes many fewer computational resources than existing techniques, and that is faster in terms of wall-clock time than existing techniques. In particular, many existing techniques rely on evaluating the performance of a large number of candidate architectures by training a network having the candidate architecture, with each candidate being the same, large size, e.g., the same size as the final candidate architecture that will be the output of the search process. This training is both time consuming and computationally intensive. The described techniques greatly reduce the time and resource consumption of this training by using a number of techniques that also result in improved performance in discovering new architectures. As a particular example, the system incrementally and greedily constructs candidate networks that will be trained (networks having “mutated architectures”), so that “full size” candidate neural networks are only trained once the space of smaller candidate neural networks has been sufficiently explored. Additionally, the system dynamically selects the number of training steps that a candidate architecture will be trained for based on the size of the candidate, reducing the time and resources consumed by the training even further, as smaller candidate neural networks can be trained for fewer training steps without adversely impacting the quality of the architecture search. Moreover, the system employs parameter value transfer when generating a mutated architecture, reducing the amount of training required for training the mutated architecture.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural architecture search system.

FIG. 2 is a flow diagram of an example process for searching for an architecture for a task neural network.

FIG. 3 is a flow diagram of an example process for selecting a weighted ensemble of candidate neural networks.

FIG. 4 shows an example of using transfer learning when initializing the parameters of a new neural network for training during the architecture search.

Like reference numbers and designations in the various drawings indicate like elements.

### DETAILED DESCRIPTION

This specification describes a system implemented as computer programs on one or more computers in one or more locations that determines an architecture for a task neural network that is configured to perform a particular neural network task.

The neural network can be trained to perform any kind of machine learning task, i.e., can be configured to receive any kind of digital data input and to generate any kind of score, classification, or regression output based on the input.

In some cases, the neural network is a neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, the task may be a keyword spotting task where, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent.

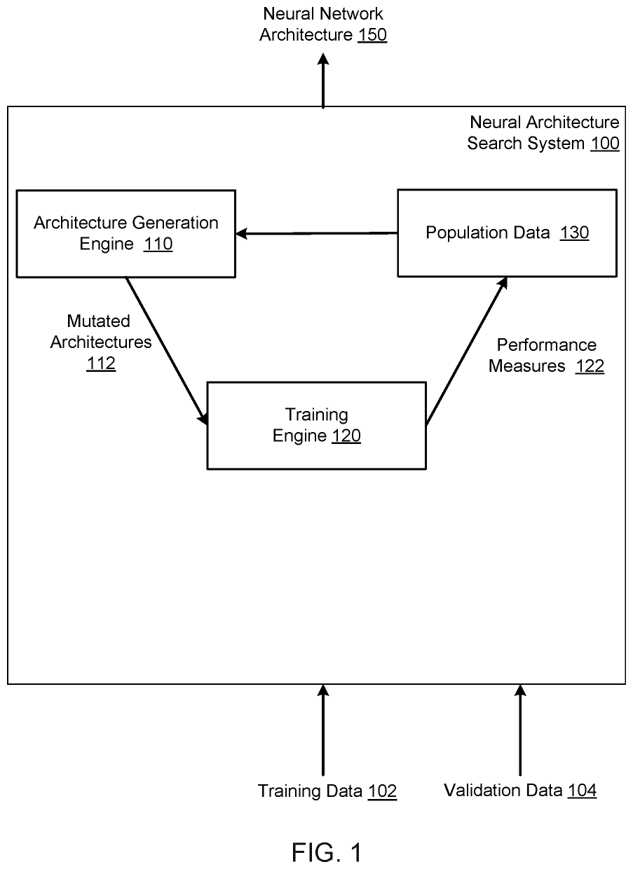

FIG. 1 shows an example neural architecture search system 100. The neural architecture search system 100 is an example of a system implemented as computer programs on one or more computers in one or more locations, in which the systems, components, and techniques described below can be implemented.

The neural architecture search system 100 is a system that obtains training data 102 for training a neural network to perform a particular task and a validation set 104 for evaluating the performance of the neural network on the particular task and uses the training data 102 and the validation set 104 to determine an architecture for a neural network that is configured to perform the particular task.

The architecture defines the number of layers in the neural network, the operations performed by each of the layers, and the connectivity between the layers in the neural network, i.e., which layers receive inputs from which other layers in the neural network.

Generally, the training data 102 and the validation set 104 both include a set of neural network inputs and, for each network input, a respective target output that should be generated by the neural network to perform the particular task. For example, a larger set of training data may have been randomly partitioned to generate the training data 102 and the validation set 104.

The system 100 can receive the training data 102 and the validation set 104 in any of a variety of ways. For example, the system 100 can receive training data as an upload from a remote user of the system over a data communication network, e.g., using an application programming interface (API) made available by the system 100, and randomly divide the uploaded data into the training data 102 and the validation set 104. As another example, the system 100 can receive an input from a user specifying which data that is already maintained by the system 100 should be used for training the neural network, and then divide the specified data into the training data 102 and the validation set 104.

Generally, the system 100 determines the architecture for the neural network by repeatedly modifying architectures in a set of candidate architectures, evaluating the performance of the modified architectures on the task, and then adding the modified architectures to the set in association with a performance measure that reflects the performance of the architecture on the task.

In particular, the system 100 maintains population data 130 specifying a set of candidate architectures and associating each candidate architecture in the set with a corresponding performance measure.

The system 100 repeatedly adds new candidate architectures and corresponding performance measures to the population data 130 by performing a search process and, after the search process has terminated, uses the performance measures for the architectures in the population data 130 to determine the final architecture for the neural network.

Each candidate architecture in the set is a tower. A tower is a neural network that includes a sequence of neural network blocks, with each block after the first block in the sequence receiving input from one or more blocks that are earlier in the sequence, receiving the network input, or both. While different architectures can include different numbers of blocks, the sequence of blocks in any given candidate includes at least one and at most a fixed, maximum number of blocks. In addition to the sequence of one or more neural network blocks, each tower may optionally include one or more pre-determined components, e.g., one or more input layers before the first block in the sequence, one or more output layers after the last block in the sequence, or both.

Each neural network block in each candidate architecture is selected from a set of possible neural network blocks. Thus, the search space for the final architecture is the set of possible combinations of neural network blocks in the set that include at most the maximum number of blocks. A neural network block is a combination of one or more neural network layers that receives one or more input tensors and generates as output one or more output tensors.

The types of neural network blocks that are in the set of possible network blocks will generally differ based on the neural network task.

For example, when the neural network is a convolutional neural network, e.g., for performing an image processing task, the blocks in the set will include blocks with different configurations of convolutional layers and, optionally, blocks with other kinds of neural network layers, e.g., fully-connected layers. An example set of blocks for a convolutional neural network is illustrated in Table 1:

TABLE 1

| BLOCK TYPE | # INPUTS | DESCRIPTION OF k | POSSIBLE k VALUES |
|---|---|---|---|
| FIXCONVₖ | 1 | OUTPUT CHANNELS | 32, 64, 96, 120 |
| RESNETₖ | 1 | FILTER SIZE | 3 × 3, 5 × 5 |
| DILATEDCONVₖ | 1 | DILATION RATE | 2, 4 |
| CONVOLUTIONₖ | 1 | FILTER SIZE | 3 × 3, 5 × 5, 1 × 7, 1 × 5, |
| | | | 1 × 3, 3 × 1, 5 × 1, 7 × 1 |
| DOWNSAMPLECONVₖ | 1 | FILTER SIZE | 3 × 3, 5 × 5 |
| NAS-A | 2 | N/A | |
| NAS-A-REDUCTION | 2 | N/A | |
| FULLYCONNₖ | 1 | HIDDEN NODES | 128, 256, 512, 1024 |

In Table 1, the system can select from different versions of each type of block by selecting a value for k. In more detail, FIXCONV is a convolution with fixed output channels. RESNET blocks refer to the residual deep learning connection, i.e., two convolutions with a skip connection. DILATEDCONV is dilated convolution layer. CONVOLUTION and DOWNSAMPLECONV are convolutional layers with different filter sizes, where DOWNSAMPLECONV has stride greater than 1 and increases the number of channels. NAS-A and NAS-A-REDUCTION are the normal and reduction NASNet cells, respectively. Finally, FULLYCONN is a fully connected layer with different number of nodes.

As another example, when the neural network is a recurrent neural network, the blocks in the set will include blocks with different configurations of recurrent layers and, optionally, other kinds of layers, e.g., fully-connected layers or projection layers. An example set of blocks for a recurrent neural network is illustrated in Table 2:

TABLE 2

| Type | β (dimensions) |
|---|---|
| RNNₖ | 64, 128, 256 |
| PROJₖ | 64, 128, 256 |
| SVDF_{k-d} | 64-4, 128-4, 256-4 |
| | 512-4, 64-8, 128-8 |
| | 256-8, 64-16 |
| | 128-16, 256-16 |

In table 2, the system can select from different versions of each block by selecting a value for Beta to specify the dimensions of the layers in the block. In Table 2, RNN is a block of one or more recurrent neural network layers of varying dimensions. PROJ is a projection layer that projects an input to an output that has varying dimensions. SV DF is a single value decomposition filter layer that approximates a fully-connected layer with a low rank approximation.

To determine the final architecture, the system 100 repeatedly performs the search process using an architecture generation engine 110 and a training engine 120.

The architecture generation engine 110 repeatedly (i) selects, based on the performance measures in the maintained data 130, a candidate architecture from the set of candidate architectures and (ii) selects a neural network block from the set of neural network blocks, e.g., randomly or using Bayesian optimization.

The architecture generation engine 110 then determines whether to (i) add the selected neural network block as a new neural network block in the candidate architecture (after the last block in the sequence) or (ii) replace one of the neural network blocks in the selected candidate architecture with the selected neural network block. Thus, the architecture generation engine 110 determines whether to expand the size of the architecture by one block or to replace an existing block in the architecture.

The architecture generation engine 120 then generates, based on the results of the determining, a mutated architecture 112 by either (i) adding the selected neural network block as a new neural network block in the selected candidate architecture or (ii) replacing one of the neural network blocks in the selected candidate architecture with the selected neural network block.

By generating the mutated architectures in this manner, the engine 120 grows architectures adaptively and incrementally via greedy mutations to reduce the sample complexity of the search process.

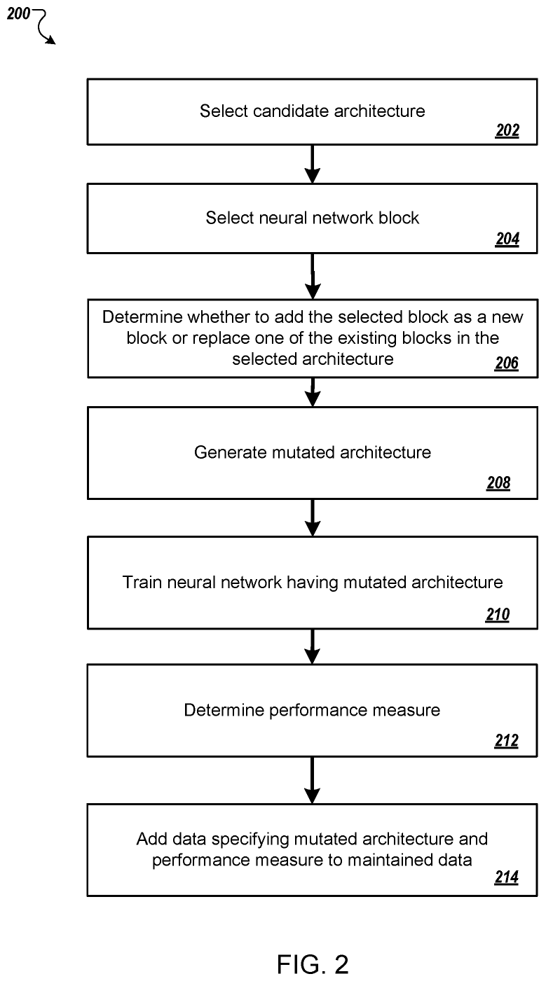

Generating a mutated architecture will be described in more detail below with reference to FIG. 2.

For each mutated architecture 112 that is generated by the engine 110, the training engine 120 trains a neural network having the mutated architecture 112 on the training data 102 and determines a performance measure 122 for the trained neural network that measures the performance of the trained neural network on the particular machine learning task, i.e., by evaluating the performance of the trained neural network on the validation data set 104. For example, the performance measure can be the loss of the trained neural network on the validation data set 104 or the result of some other measure of model accuracy when computed over the validation data set 104.

The system 100 then adds, to the maintained data, data specifying the mutated architecture 112 and data associating the mutated architecture 112 with the determined performance measure 122.

Once the search process has been completed, the system 100 can select a final architecture for the neural network using the architectures and performance measures in the maintained data 130.

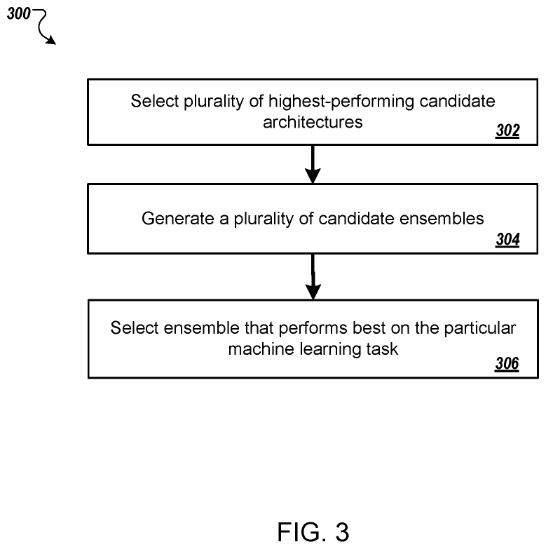

Selecting a final architecture is described in more detail below with reference to FIG. 3.

The neural network search system 100 can then output architecture data 150 that specifies the final architecture of the neural network, i.e., data specifying the layers that are part of the neural network, the connectivity between the layers, and the operations performed by the layers. For example, the neural network search system 100 can output the architecture data 150 to the user that submitted the training data.

In some implementations, instead of or in addition to outputting the architecture data 150, the system 100 instantiates an instance of the neural network having the determined architecture and with trained parameters, e.g., either trained from scratch by the system after determining the final architecture, making use of the parameter values generated as a result of the search process, or generated by fine-tuning the parameter values generated as a result of the search process, and then uses the trained neural network to process requests received by users, e.g., through the API provided by the system. That is, the system 100 can receive inputs to be processed, use the trained neural network to process the inputs, and provide the outputs generated by the trained neural network or data derived from the generated outputs in response to the received inputs.

FIG. 2 is a flow diagram of an example process 200 for searching for an architecture for a task neural network. For convenience, the process 200 will be described as being performed by a system of one or more computers located in one or more locations. For example, a neural architecture search system, e.g., the neural architecture search system 100 of FIG. 1, appropriately programmed, can perform the process 200.

As described above, during the search for an architecture the system maintains population data.

The system can then repeatedly perform the process 200 to update the set of candidate architectures in the maintained population data.

In some implementations, the system can distribute the certain steps of the process 200 across multiple devices within the system. As a particular example, multiple different heterogeneous or homogenous devices can asynchronously perform the process 200 to repeatedly update population data that is shared between all of the devices.

The system selects, based on the performance measures in the population data, a candidate architecture from the set of candidate architectures (step 202).

As one example, the system can select, from the set of candidate architectures, a plurality of candidate architectures having the best performance measures, e.g., a fixed size subset of the set that have the best performance measures, and then sample the candidate architecture from the plurality of candidate architectures.

The system selects a neural network block from the set of neural network blocks (step 204).

In some implementations, the system selects a neural network block randomly from the set of neural network blocks.

In some other implementations, the system selects the block such that blocks that are more likely to increase the performance of the architecture are selected with a higher frequency. As a particular example, the system can select a neural network block from the set of neural network blocks using Baysian optimization in order to bias the selection towards blocks that are more likely improve the performance of the candidate neural network.

The system determines whether to (i) add the selected neural network block as a new neural network block in the candidate architecture or (ii) replace one of the neural network blocks in the selected candidate architecture with the selected neural network block (step 206).

When determining whether to (i) add the selected neural network block as a new neural network block in the selected candidate architecture or (ii) replace one of the neural network blocks in the selected candidate architecture with the selected neural network block, the system can employ any of a variety of techniques that ensure that the search process adequately explores the space of possible architectures with a given number of blocks before moving on to architectures with a larger number of blocks.

For example, the system can determine to add the selected neural network block as a new block only if the number of neural network blocks in the selected candidate architecture is less than a predetermined maximum number of neural network blocks. That is, the system will not add a new block to the selected candidate architecture if the candidate architecture already includes the maximum number of blocks.

As another example, the system can sample a value from a predetermined distribution and determine to add the selected neural network block as a new block only if the sampled value satisfies a threshold value. For example, the system can sample a value from the uniform distribution between zero and one, inclusive and only determine to add the selected neural network block as a new block only if the sampled value is less than a fixed value between zero and one. The fixed value between zero and one can be selected to govern how aggressively the system will search the space at any given number of blocks.

As yet another example, the system can determine a number of architectures in the set of candidate architectures that have the same number of neural network blocks as the selected candidate architecture and determine to add the selected neural network block as a new block only if the number of architectures in the set of candidate architectures that have the same number of neural network blocks as the selected candidate architecture exceeds a threshold, e.g., exceeds a threshold value.

As yet another example, the system can determine a number of architectures that are currently in the set of candidate architectures and determine to add the selected neural network block as a new block only if the number of architectures in the set of candidate architectures exceeds a threshold. For example, the system can determine the threshold based on a predetermined exploration factor, i.e., a fixed positive value, and the current number of blocks in the selected candidate architecture, e.g., as the product of the exploration factor and the number of blocks.

In some cases, the system may jointly employ multiple ones of these techniques. As a particular example, the system can determine to add the new block as a new neural network block if and only if (i) the number of neural network blocks in the selected candidate architecture is less than the predetermined maximum number of neural network blocks, (ii) if the sampled value satisfies a threshold value, and (iii) the number of architectures in the set of candidate architectures exceeds a threshold that is determined based on the current number of blocks in the selected candidate architecture.

The system generates a mutated architecture by either (i) adding the selected neural network block as a new neural network block in the selected candidate architecture or (ii) replacing one of the neural network blocks in the selected candidate architecture with the selected neural network block (step 208).

In other words, in response to determining to add the selected neural network block as a new neural network block, the system adds the selected neural network block as a new neural network block in the selected candidate architecture, i.e., by adding the new neural network block as a new block at the end of the sequence after the block that is currently last in the sequence.

In response to determining to replace one of the neural network blocks in the selected candidate architecture with the selected neural network block, the system replaces one of the neural network blocks in the selected candidate architecture with the selected neural network block. As a particular example, the system can randomly identify a neural network block from the selected candidate architecture; and replacing the randomly identified neural network block with the selected neural network block.

The system trains a neural network having the mutated architecture on the training data, i.e., using a conventional machine learning technique that is appropriate for the task that the task neural network is configured to perform (step 210).

In some implementations, the system trains each neural network for the same predetermined number of training iterations or until convergence.

In other implementations, however, the system trains different neural networks for different numbers of training iterations. In particular, the system can determine a number of training iterations for which to train the neural network based on the number of neural network blocks in the mutated architecture, i.e., with the number of training iterations increasing as the number of neural network blocks in the mutated architecture increases. For example, the system can linearly increase the number of iterations with the number of blocks in the architecture. Thus, during the early stages of the search, shallow architectures having relatively few blocks will train for a shorter time, increasing the computational efficiency of the overall framework.

Moreover, in some implementations, the system trains the neural network having the mutated architecture starting from newly initialized values of the parameters of the blocks in the mutated architecture.

In some other implementations, however, the system makes use of transfer learning to speed up the training of the new neural network. In particular, the system leverages the previously trained parameters for those blocks of the mutated architecture that are identical with respect to the selected candidate architecture when initiating the training of the neural network.

More specifically, when transfer learning is used, the system also includes in the maintained population data, for each candidate architecture, current parameter values for the parameters of each neural network block in the candidate architecture, i.e., the parameter values for each of the blocks after the neural network having the candidate architecture was trained.

The system can use these current parameter values for the selected candidate architecture when initializing the parameter values of the neural network blocks in the mutated candidate architecture. In particular, the system can initialize the parameter values differently for different blocks of the mutated architecture depending on where the selected neural network block was inserted into the selected candidate architecture.

More specifically, for any neural network block in the selected candidate architecture that precedes the selected neural network block in the candidate architecture, the system can initialize the values of the parameters of the neural network block to the current values of the parameters for the block (within the selected candidate architecture) in the maintained data.

For the selected neural network block and any neural network block in the candidate architecture that is after the selected neural network block in the candidate architecture, the system initializes the values of the parameters of the neural network block to newly initialized values.

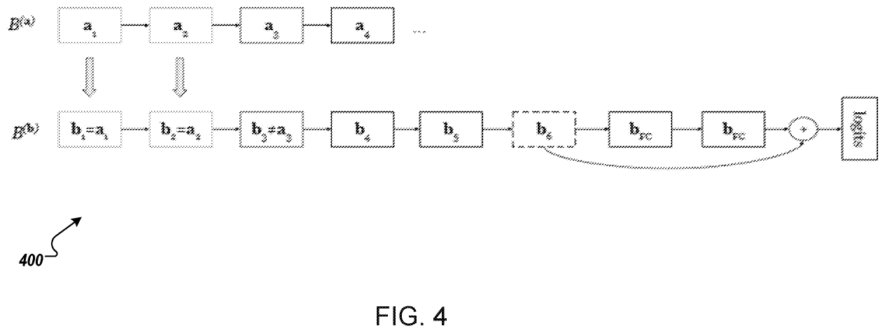

This technique is described in more detail below with reference to FIG. 4.

The system determines a performance measure for the trained neural network that measures the performance of the trained neural network on the particular machine learning task (step 212).

In particular, the system can determine the performance of the trained neural network on the validation data set, i.e., the performance measure can be an appropriate measure that measures the performance of the trained neural network on the validation data set. Examples of performance measures that may be appropriate for different tasks include classification accuracy measures, intersection over union (IoU) measures for regression tasks, edit distance measures for text generation tasks, and so on.

The system adds, to the maintained population data, data specifying the mutated architecture and data associating the mutated architecture with the determined performance measure (step 214). When transfer learning is being used, the system also adds, to the maintained data, the values of the parameters of the neural network blocks in the mutated architecture after the training of the neural network having the mutated architecture.

Thus, by repeatedly performing iterations of the process 200, the system can repeatedly update the population data to include candidate architectures with better performance measures.

After criteria for terminating performing iterations of the process 200 have been satisfied, e.g., after a fixed number of iterations have been performed, after a fixed time has elapsed, after a termination input has been received from a user of the system, or after the performance measure for the highest-performing architecture in the data satisfies a threshold, the system determines a final architecture for the task neural network.

As one example, the system can select one of the candidate architectures in the set as the architecture for the task neural network based on the performance measures. As a particular example, the system can select the candidate architecture in the set having the best performance measure as the final architecture for the task neural network. As another particular example, the system can select a fixed number of candidate architectures from the set that have the best performance measures, further train a neural network having each of the selected architectures, determine an updated performance measure for each of the selected architectures based on the performance of the further trained neural networks on the validation data set, and select, as the final architecture for the task neural network, the candidate architecture having the best updated performance measure.

As another example, the system can determine the architecture of the task neural network to be a weighted ensemble of a plurality of candidate architectures in the set, i.e., a weighted ensemble that includes a fixed number p of candidate architectures from the set where p is an integer greater than one. In other words, in this example, the architecture of the task neural network is an architecture that generates a final output for the neural network task as a weighted combination of the outputs generated by the plurality of candidate architectures in the ensemble. As a particular example, each architecture in the ensemble can be assigned the same weight, i.e., a weight equal to 1/p, in the combination. As another particular example, the weights assigned to each architecture in the combination can be learned.

An example technique for generating a weighted ensemble is described in more detail below with reference to FIG. 3

FIG. 3 is a flow diagram of an example process 300 for selecting a weighted ensemble of candidate neural networks. For convenience, the process 300 will be described as being performed by a system of one or more computers located in one or more locations. For example, a neural architecture search system, e.g., the neural architecture search system 100 of FIG. 1, appropriately programmed, can perform the process 300.

The system selects a plurality of highest-performing candidate architectures from the set of candidate architectures based on the performance measures (step 302). The system generally selects a number of architectures that is greater than the fixed numberp in the ensemble. For example, the system can select the P architectures in the set that have the best performance measures, where P is an integer greater than p.

The system generates a plurality of candidate ensembles, with each candidate ensemble including a different combination ofp candidate architectures from the plurality of highest-performing candidate architectures (step 304). In some implementations, the system generates a respective ensemble for each possible different combination ofp candidate architectures from the plurality of highest-performing candidate architectures. In some other implementations, the system generates a fixed number of candidate ensembles, i.e., by repeatedly randomly sampling sets ofp candidate architectures from the plurality of highest-performing candidate architectures.

The system then selects, as the determined architecture, the ensemble of the plurality of candidate ensembles that performs best on the particular machine learning task (step 306). In particular, the system can determine the performance of each candidate ensemble on the validation data set as described above, but with the performance of an ensemble being based on the weighted combinations of outputs generated by the candidate architectures in the ensemble.

When the weights assigned to different architectures in the weighted combination are learned, the system can train each ensemble on all or part of the training data set in order to fine tune the weights (and, optionally, the parameters of the networks in the candidate ensemble) prior to determining the performance of each candidate ensemble on the validation data set.

FIG. 4 shows an example of using transfer learning when initializing the parameters of a new neural network for training during the architecture search.

In the example of FIG. 4, a mutated architecture B(b) has been generated from a selected candidate architecture B(a).

The selected candidate architecture includes an initial sequence of blocks ai through a₆, followed by two fully-connected blocks afc and finally followed by a logits layer that generates a respective score for each of multiple categories (although only a₁ through a₃ are shown in the Figure). In some cases, the fully-connected blocks afc and the logits layer can be fixed for all the candidate architectures in the set, while the blocks in the initial sequence of blocks can be learned through the search process.

The mutated architecture includes an initial sequence of blocks b₁ through b₆, followed by two fully-connected blocks bfc and finally followed by the logits layer.

To generate the mutated architecture from the selected candidate architecture, the system replaced the block a₃ in the selected candidate architecture with a new block b₃. Thus, block a₁ and a₂ are the same as blocks b₁ and b₂, respectively, while block a₃ is not the same as block b₃. Therefore, when initializing the parameters of blocks b₁ and b₂, the system initializes the values of the parameters of block b₁ to the current values of the parameters for the block a₁ in the maintained data and initializes the values of the parameters initializes the values of the parameters of block b₂ to the current values of the parameters for the block a₂ in the maintained data. This transfer is illustrated by an arrow in FIG. 4.

Because block b₃ does not match block a₃, for block b₃ and the blocks that are after block b₃ in the mutated architecture, the system initializes the values of the parameters of the neural network block to newly initialized values, e.g., by setting the values to random values using a conventional random parameter initialization technique.

By initializing the parameters using this transfer technique, the system shortens the training time and, accordingly, the amount of computational resources, required to train the new neural network while allowing the lower blocks learn features which can be extrapolated across architectures, improving the quality of the final determined architecture.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving training data for training a task neural network to perform a particular machine learning task; and
determining an architecture for the task neural network, comprising:
maintaining data specifying a set of candidate architectures and associating each candidate architecture in the set with a corresponding performance measure, wherein each candidate architecture in the set is a sequence of one or more neural network blocks, and wherein each neural network block in each candidate architecture is selected from a set of possible neural network blocks; and
repeatedly performing the following operations:
selecting, based on the performance measures in the maintained data, a candidate architecture from the set of candidate architectures;
selecting a neural network block from the set of neural network blocks;
determining whether to (i) add the selected neural network block as a new neural network block in the candidate architecture or (ii) replace one of the neural network blocks in the selected candidate architecture with the selected neural network block;
based on the determining, generating a mutated architecture by either (i) adding the selected neural network block as a new neural network block in the selected candidate architecture or (ii) replacing one of the neural network blocks in the selected candidate architecture with the selected neural network block;
training a neural network having the mutated architecture on the training data;
determining a performance measure for the trained neural network that measures the performance of the trained neural network on the particular machine learning task; and
adding, to the maintained data, data specifying the mutated architecture and data associating the mutated architecture with the determined performance measure.

2. The method of claim 1, wherein determining whether to (i) add the selected neural network block as a new neural network block in the selected candidate architecture or (ii) replace one of the neural network blocks in the selected candidate architecture with the selected neural network block comprises:
determining whether the number of neural network blocks in the selected candidate architecture is less than a maximum number of neural network blocks; and
determining to add the selected neural network block as a new block only if the number of neural network blocks in the selected candidate architecture is less than a maximum number of neural network blocks.

3. The method of claim 1, wherein determining whether to (i) add the selected neural network block as a new neural network block in the selected candidate architecture or (ii) replace one of the neural network blocks in the selected candidate architecture with the selected neural network block comprises:
sampling a value from predetermined distribution; and
determining to add the selected neural network block as a new block only if the sampled value satisfies a threshold value.

4. The method of claim 1, wherein determining whether to (i) add the selected neural network block as a new neural network block in the selected candidate architecture or (ii) replace one of the neural network blocks in the selected candidate architecture with the selected neural network block comprises:
determining a number of architectures in the set of candidate architectures that have the same number of neural network blocks as the selected candidate architecture; and
determining to add the selected neural network block as a new block only if the number of architectures in the set of candidate architectures that have the same number of neural network blocks as the selected candidate architecture exceeds a threshold.

5. The method of claim 1, wherein determining whether to (i) add the selected neural network block as a new neural network block in the selected candidate architecture or (ii) replace one of the neural network blocks in the selected candidate architecture with the selected neural network block comprises:
determining a number of architectures in the set of candidate architectures; and
determining to add the selected neural network block as a new block only if the number of architectures in the set of candidate architectures exceeds a threshold.

6. The method of claim 1, wherein generating a mutated architecture by either (i) adding the selected neural network block as a new neural network block in the selected candidate architecture or (ii) replacing one of the neural network blocks in the selected candidate architecture with the selected neural network block comprises:
in response to determining to replace one of the neural network blocks:
randomly identifying a neural network block from the selected candidate architecture; and
replacing the randomly identified neural network block with the selected neural network block.

7. The method of claim 1, wherein the maintained data also includes, for each candidate architecture, current parameter values for the parameters of each neural network block in the candidate architecture, wherein training comprises:
for any neural network block in the selected candidate architecture that precedes the selected neural network block in the candidate architecture, initializing the values of the parameters of the neural network block to the current values of the parameters in the maintained data; and
for the selected neural network block and any neural network block in the candidate architecture that is after the selected neural network block in the candidate architecture, initializing the values of the parameters of the neural network block to newly initialized values, and wherein the operations further comprise:
adding, to the maintained data, the values of the parameters of the neural network blocks in the mutated architecture after the training of the neural network having the mutated architecture.

8. The method of claim 1, wherein the training comprises:
determining a number of training iterations for which to train the neural network based on the number of neural network blocks in the mutated architecture, wherein the number of training iterations increases as the number of neural network blocks increases.

9. The method of claim 1, wherein selecting the candidate architecture comprises:
selecting, from the set of candidate architectures, a plurality of candidate architectures having the best performance measures; and
sampling the candidate architecture from the plurality of candidate architectures.

10. The method of claim 1, further comprising:
using a trained task neural network having the determined architecture to perform the particular machine learning task.

11. The method of claim 1, further comprising:
after repeatedly performing the operations, selecting one of the candidate architectures in the set as the architecture for the task neural network based on the performance measures.

12. The method of claim 1, further comprising:
after repeatedly performing the operations, determining the architecture of the task neural network to be a weighted ensemble of a plurality of candidate architectures in the set.

13. The method of claim 12, wherein the weighted ensemble includes a fixed number p of candidate architectures, and wherein determining the architecture comprises:
after repeatedly performing the operations:
selecting a plurality of highest-performing candidate architectures from the set of candidate architectures based on the performance measures;
generating a plurality of candidate ensembles, each candidate ensemble including a different combination ofp candidate architectures from the plurality of highest-performing candidate architectures; and
selecting, as the determined architecture, the ensemble of the plurality of candidate ensembles that performs best on the particular machine learning task.

14. The method of claim 1, wherein determining a performance measure for the trained neural network that measures the performance of the trained neural network on the particular machine learning task comprises:
determining a performance of the trained neural network on a validation data set.

15. The method of claim 1, wherein selecting a neural network block from the set of neural network blocks comprises:
selecting a neural network block from the set of neural network blocks using Baysian optimization.

16. The method of claim 1, wherein selecting a neural network block from the set of neural network blocks comprises:
selecting a neural network block randomly from the set of neural network blocks.

17. A system comprising one or more computers and one or more storage devices storing instructions that when executed by the one or more computers cause the one or more computers to perform operations comprising:
receiving training data for training a task neural network to perform a particular machine learning task; and
determining an architecture for the task neural network, comprising:
maintaining data specifying a set of candidate architectures and associating each candidate architecture in the set with a corresponding performance measure, wherein each candidate architecture in the set is a sequence of one or more neural network blocks, and wherein each neural network block in each candidate architecture is selected from a set of possible neural network blocks; and
repeatedly performing the following operations:
selecting, based on the performance measures in the maintained data, a candidate architecture from the set of candidate architectures;
selecting a neural network block from the set of neural network blocks;
determining whether to (i) add the selected neural network block as a new neural network block in the candidate architecture or (ii) replace one of the neural network blocks in the selected candidate architecture with the selected neural network block;
based on the determining, generating a mutated architecture by either (i) adding the selected neural network block as a new neural network block in the selected candidate architecture or (ii) replacing one of the neural network blocks in the selected candidate architecture with the selected neural network block;
training a neural network having the mutated architecture on the training data;
determining a performance measure for the trained neural network that measures the performance of the trained neural network on the particular machine learning task; and
adding, to the maintained data, data specifying the mutated architecture and data associating the mutated architecture with the determined performance measure.

18. The system of claim 17, wherein determining whether to (i) add the selected neural network block as a new neural network block in the selected candidate architecture or (ii) replace one of the neural network blocks in the selected candidate architecture with the selected neural network block comprises:
determining whether the number of neural network blocks in the selected candidate architecture is less than a maximum number of neural network blocks; and
determining to add the selected neural network block as a new block only if the number of neural network blocks in the selected candidate architecture is less than a maximum number of neural network blocks.

19. The system of claim 17, wherein determining whether to (i) add the selected neural network block as a new neural network block in the selected candidate architecture or (ii) replace one of the neural network blocks in the selected candidate architecture with the selected neural network block comprises:
sampling a value from predetermined distribution; and
determining to add the selected neural network block as a new block only if the sampled value satisfies a threshold value.

20. One or more non-transitory computer-readable media storing instructions that when executed by one or more computers cause the one or more computers to perform operations comprising:
receiving training data for training a task neural network to perform a particular machine learning task; and
determining an architecture for the task neural network, comprising:
maintaining data specifying a set of candidate architectures and associating each candidate architecture in the set with a corresponding performance measure, wherein each candidate architecture in the set is a sequence of one or more neural network blocks, and wherein each neural network block in each candidate architecture is selected from a set of possible neural network blocks; and
repeatedly performing the following operations:
selecting, based on the performance measures in the maintained data, a candidate architecture from the set of candidate architectures;
selecting a neural network block from the set of neural network blocks;
determining whether to (i) add the selected neural network block as a new neural network block in the candidate architecture or (ii) replace one of the neural network blocks in the selected candidate architecture with the selected neural network block;
based on the determining, generating a mutated architecture by either (i) adding the selected neural network block as a new neural network block in the selected candidate architecture or (ii) replacing one of the neural network blocks in the selected candidate architecture with the selected neural network block;
training a neural network having the mutated architecture on the training data;
determining a performance measure for the trained neural network that measures the performance of the trained neural network on the particular machine learning task; and
adding, to the maintained data, data specifying the mutated architecture and data associating the mutated architecture with the determined performance measure.
